(19) United States
(12) Patent Application Publication
(10) Pub. No.: US 2017/0040935 A1
(43) Pub. Date: Feb. 9, 2017

(54) Solar Panel Case

(71) Applicant: Iometers, LLC, Addison, TX (US)

(72) Inventor: Scott Brown, Addison, TX (US)

(21) Appl. No.: 15/229,387

(22) Filed: Aug. 5, 2016

Related U.S. Application Data
(60) Provisional application No. 62/202,012, filed on Aug. 6, 2015.

(51) Int. Cl. H02S 30/10; H02S 40/38; H02S 20/20

(52) U.S. Cl. CPC H02S 30/10; H02S 20/20; H02S 40/38

(57) ABSTRACT

A solar panel system may include a case having built-in space for housing equipment, such as advanced metering infrastructure (AMI) hardware and other components. The solar panel case may provide a face angled at approximately 45 degrees for mounting at least one solar panel. A modular system that may include a battery holder may be easily placed inside of the case and quickly removed from the case. The solar panel case and solar panel system may be provided to simultaneously house equipment and support at least one solar panel.

### CROSS REFERENCE TO RELATED APPLICATION

The present application claims priority to U.S. Patent Application No. 62/220,012 filed Aug. 6, 2015, entitled “SOLAR PANEL CASE,” which is incorporated herein by reference in its entirety.

### TECHNICAL FIELD

The disclosure relates generally to a solar panel system including a case. In particular, the disclosure relates to a solar panel case for housing advanced metering infrastructure (AMI) hardware or similar applications.

### BACKGROUND

Generally, mounting devices and support structures support solar panels. These mounting devices and support structures may be angled in order to orient solar panels at a certain angle for receiving light rays. However, no mounting devices and support structures provide a case for both supporting solar panels and housing equipment, such as AMI hardware, at a 45-degree angle.

### SUMMARY

Embodiments of the present disclosure may provide a solar panel case and a solar panel system including a solar panel holder provided to support at least one solar panel. A modular system may be provided to secure equipment, such as advanced metering infrastructure (AMI) hardware, inside of the solar panel case, and the modular system may be removable. Furthermore, a face of the case may be angled at approximately 45 degrees with respect to a base of the case. It is an object of the present disclosure to provide a solar panel case for housing AMI and supporting at least one solar panel, simultaneously.

An embodiment of the present disclosure may provide a solar panel case that may include a solar panel holder that may be provided to support at least one solar panel. A modular system may be provided to secure and house equipment in an interior of the case, and the modular system may be removable. A face may be angled at approximately 45 degrees with respect to a base of the case. The face may be provided to form a frame that may secure the at least one solar panel to the case. The modular system may house a battery holder and a controller. The solar panel holder may secure the at least one solar panel in the interior of the case. The solar panel holder may secure the at least one solar panel to an exterior of the case. The solar panel holder may form a tight seal with the face of the case and may be provided to prevent liquid and solids from entering the interior of the case. The modular system may be fixed in the interior of the case, may includes at least one compartment, and may maximize space and efficiency of the case. The face may be perpendicular to the base of the case and may maximize an amount of light that may be received by the at least one solar panel. One or more mounting components may be attached through a side of the case, and the components may secure the case to a supporting surface. The modular system may provide safe removal of the equipment in the interior of the case and may be secured inside of a recess of the base of the case. The case may be configured to house advanced metering infrastructure hardware while supporting the at least one solar panel secured to the case.

An embodiment of the present disclosure may provide a solar panel system that may include a case that may have a face angled at approximately 45 degrees with respect to a base of the case. At least one solar panel may be mounted inside of a holder, and the holder may be provided to secure the at least one solar panel to an exterior of the case. A removable battery holder may be secured in an interior of the case. A modular system may be configured to hold equipment that may include the battery holder in the interior of the case. The face may be provided perpendicular to the base and may maximize an amount of light that may be received by the at least one solar panel. The holder may secure the at least one solar panel inside of the case or outside of the case. The modular system may be removable and may provide safe removal of the equipment that may be held in the interior of the case. The modular system may include at least one compartment and may maximize space and efficiency of the case. One or more mounting components may be provided to secure the case to a supporting surface. The modular system may be secured inside of a recess of the base of the case. The case may be configured to house advanced metering infrastructure hardware while supporting the at least one solar panel secured to the case.

Other technical features may be readily apparent to one skilled in the art from the following drawings, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 depicts an exploded perspective view of a solar panel case according to an embodiment of the present disclosure;

FIG. 2 depicts a perspective rear view of a solar panel case according to an embodiment of the present disclosure;

FIG. 3 depicts a perspective front view of an open solar panel case according to an embodiment of the present disclosure;

FIG. 4 depicts a perspective front view of an open solar panel case including mounting components according to an embodiment of the present disclosure;

FIG. 5 depicts a perspective front view of an open solar panel case including equipment according to an embodiment of the present disclosure;

FIG. 6 depicts a sectional view of a solar panel case according to an embodiment of the present disclosure; and

FIG. 7 depicts a perspective view of a modular assembly that may secure equipment within a solar panel case according to an embodiment of the present disclosure.

### DETAILED DESCRIPTION

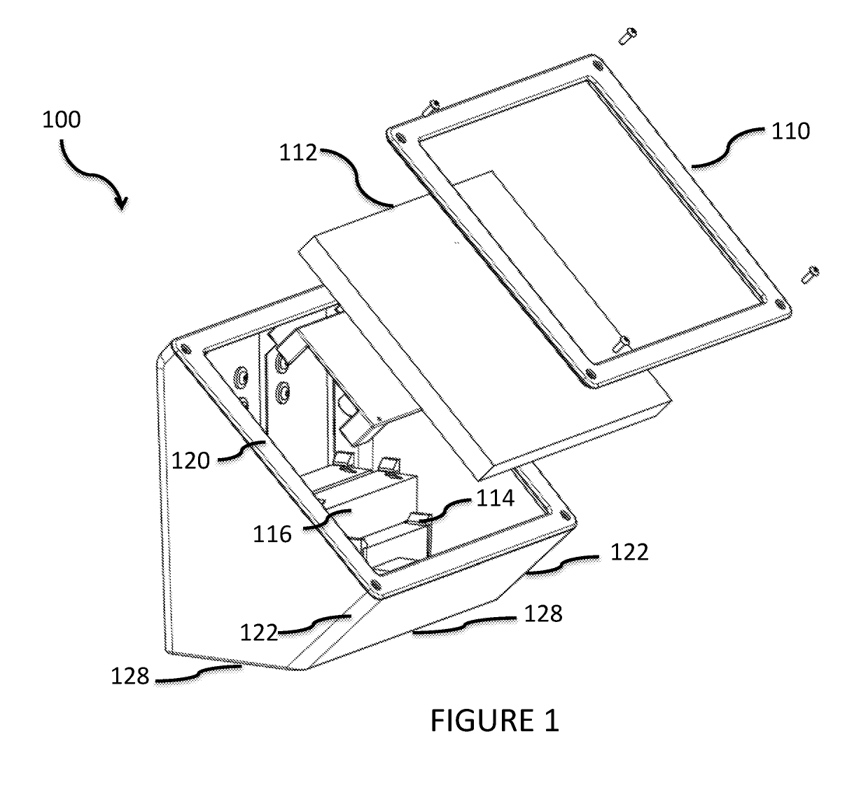

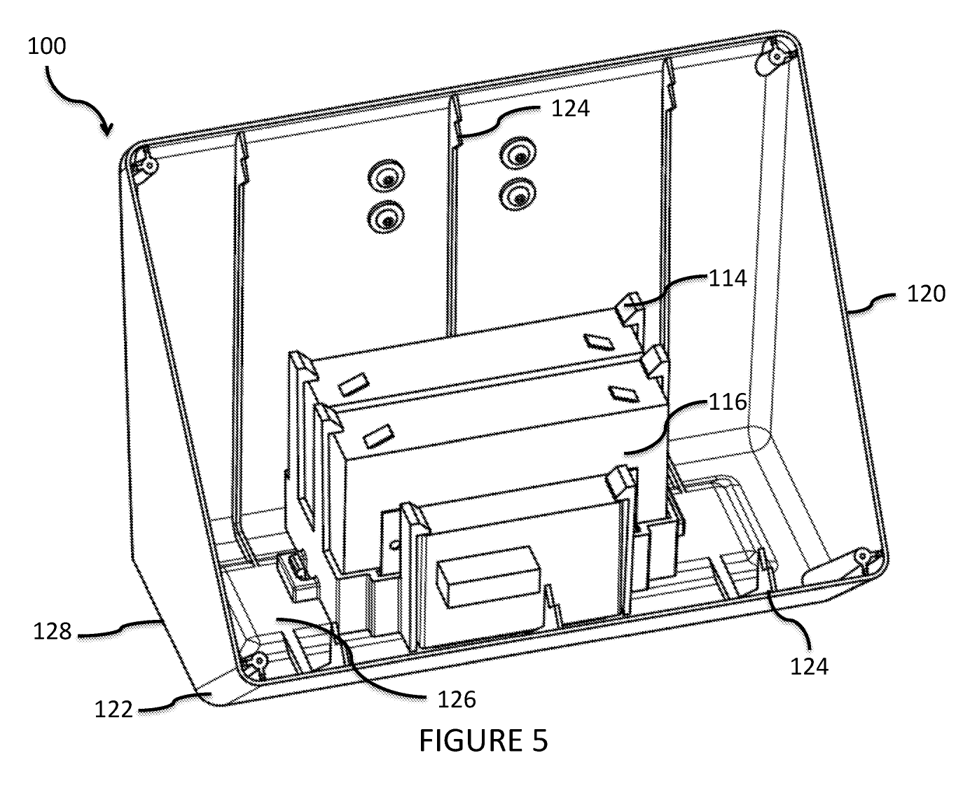

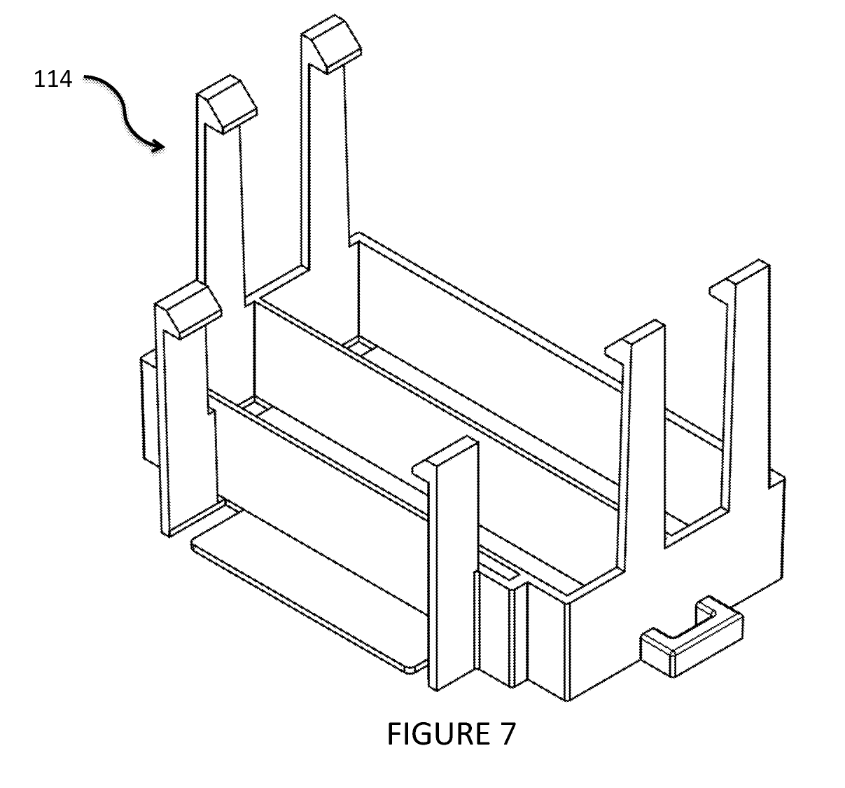

The present disclosure generally provides a solar panel case including a solar panel (FIG. 1), a solar panel holder attached to a face of the case (FIG. 1), a battery holder (FIG. 5), and a modular system (FIG. 7). The case may provide the solar panel at approximately a 45-degree angle with respect to a base of the case and house equipment, such as advanced metering infrastructure (AMI) hardware.

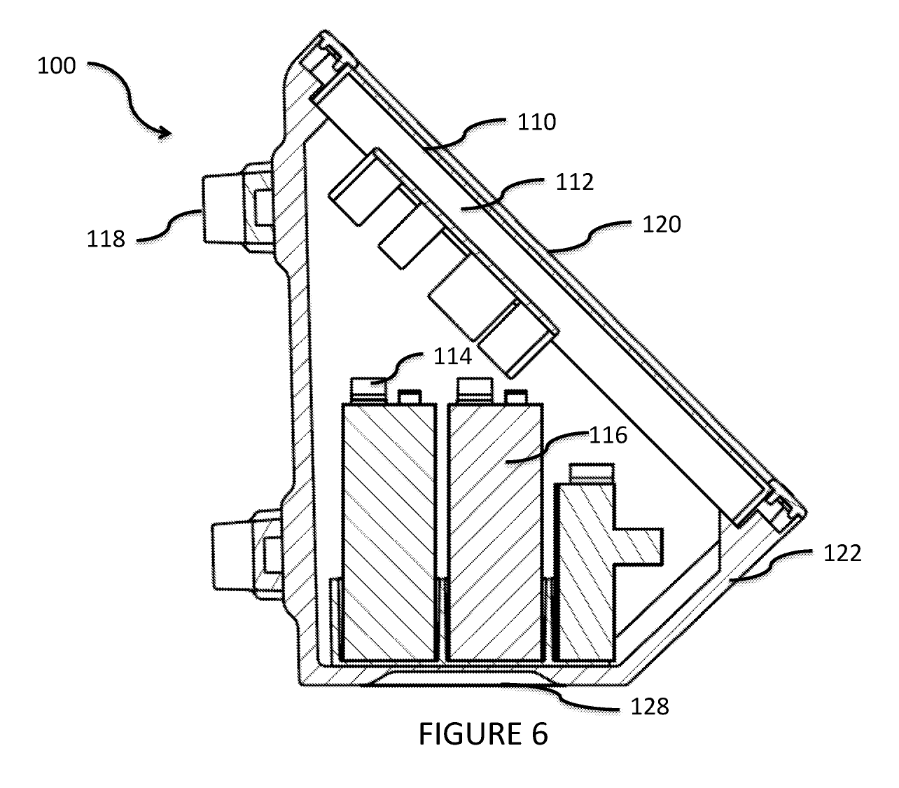

As shown in FIGS. 1-6 according to an embodiment of the present disclosure, case 100 may include face 120, sides 122, and base 128. Sides 122 may be laterally arranged between base 128 and face 120, so as to support face 120 at approximately a 45-degree angle. Face 120 may form a frame to which holder 110 may secure solar panel 112 to case 100, so as to provide solar panel 112 at an angle of approximately 45 degrees (FIG. 1 and FIG. 7). By providing face 120 and solar panel 112 at approximately a 45-degree angle, the maximum amount of light may be received by solar panel 112. It should be appreciated that case 100 provides a more efficient solar panel system, as no motor or mechanical components should be required in order to set solar panel 112 at an angle of approximately 45 degrees. Further regarding FIGS. 1-6, case 100 may provide an area for securing solar panel 112 to face 110 and an area for storing equipment 116 (FIG. 1, FIG. 5, and FIG. 6). It should be appreciated that equipment may include, but is not limited to, a battery holder, a controller, and AMI hardware. It should be appreciated that by securing solar panel 112 to case 100, case 100 may be sealed, thereby preventing, or at least reducing the likelihood of, liquid and debris from entering the interior of case 100. It should further be appreciated that solar panel 112 may be secured to an exterior of case 100 using any attachment means including, but not limited to, an adhesive, a snap-fit, and/or other hardware without departing from the present disclosure. It should be appreciated that face 120 and solar panel 112 may be arranged at any angle between less than approximately 90 degrees and greater than 0 degrees with respect to base 128. It should further be appreciated that case 100 may assume any shape and size.

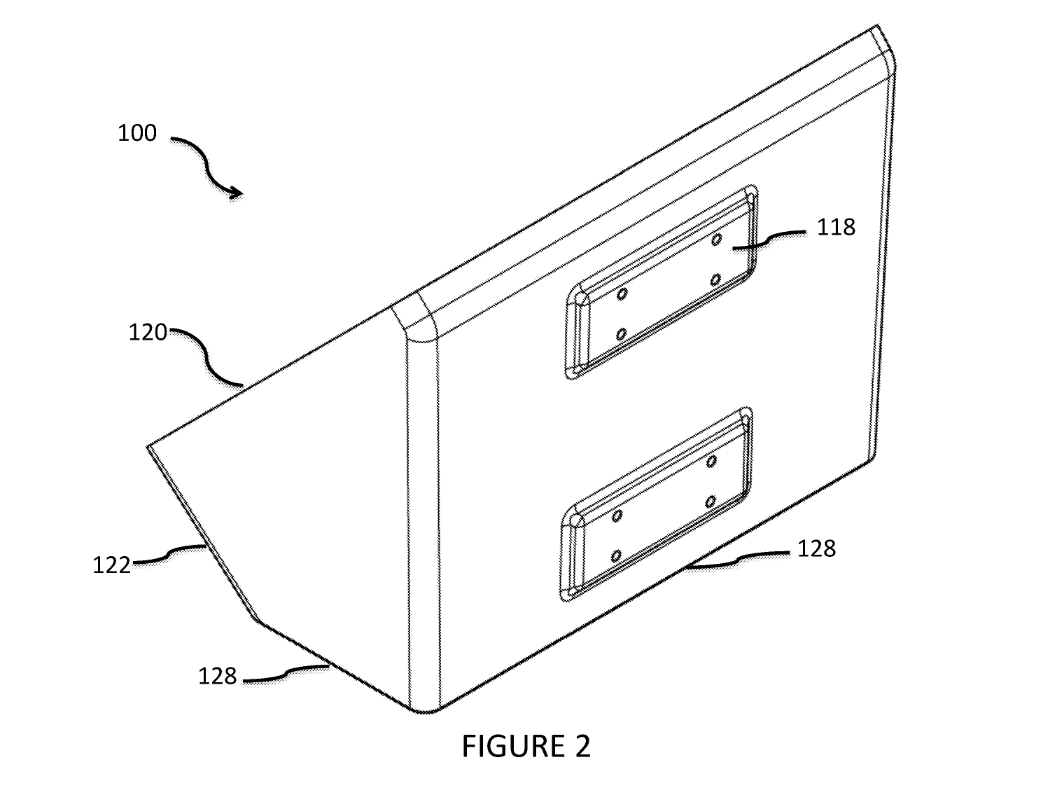

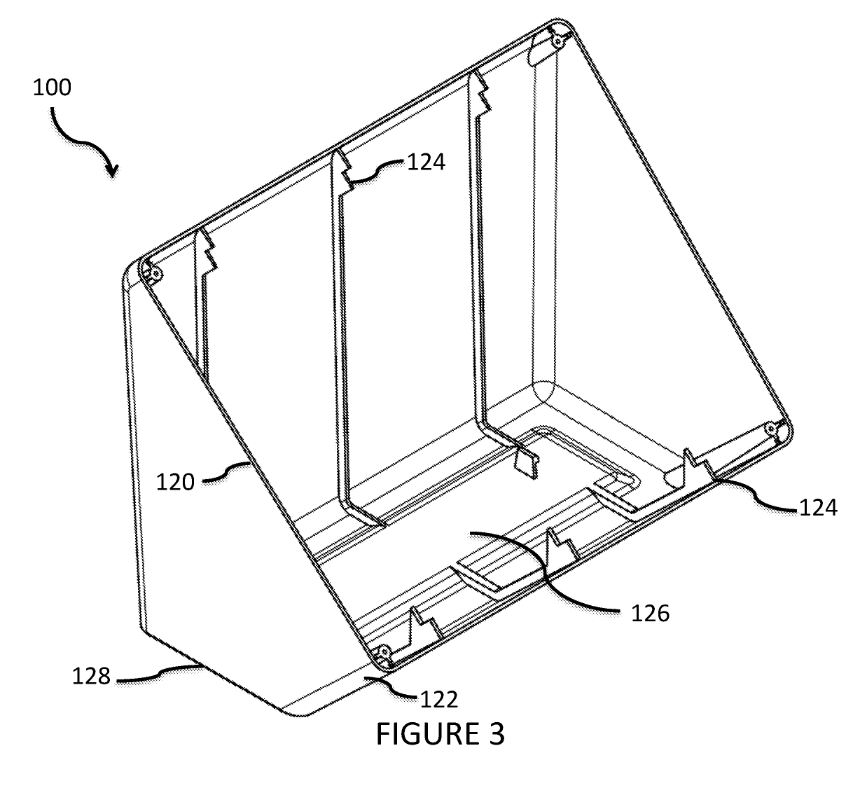

Referring to FIG. 2 according to an embodiment of the present disclosure, mounting components 118 may be arranged through a side of case 100. One or more mounting components 118 may provide the tools necessary to attach case 100 to a supporting surface. It should be appreciated that mounting components 118 may be arranged anywhere along case 100. It should also be appreciated that mounting components 118 may include hardware arranged along the interior and/or exterior of case 100. It should further be appreciated that mounting components 118 may include, but are not limited to, clamps, bolts, screws, lugs, and other types of mounting hardware. It should further be appreciated that there may be embodiments of the present disclosure wherein mounting components 118 may not be required (FIG. 3) in order to attach case 100 to a supporting surface.

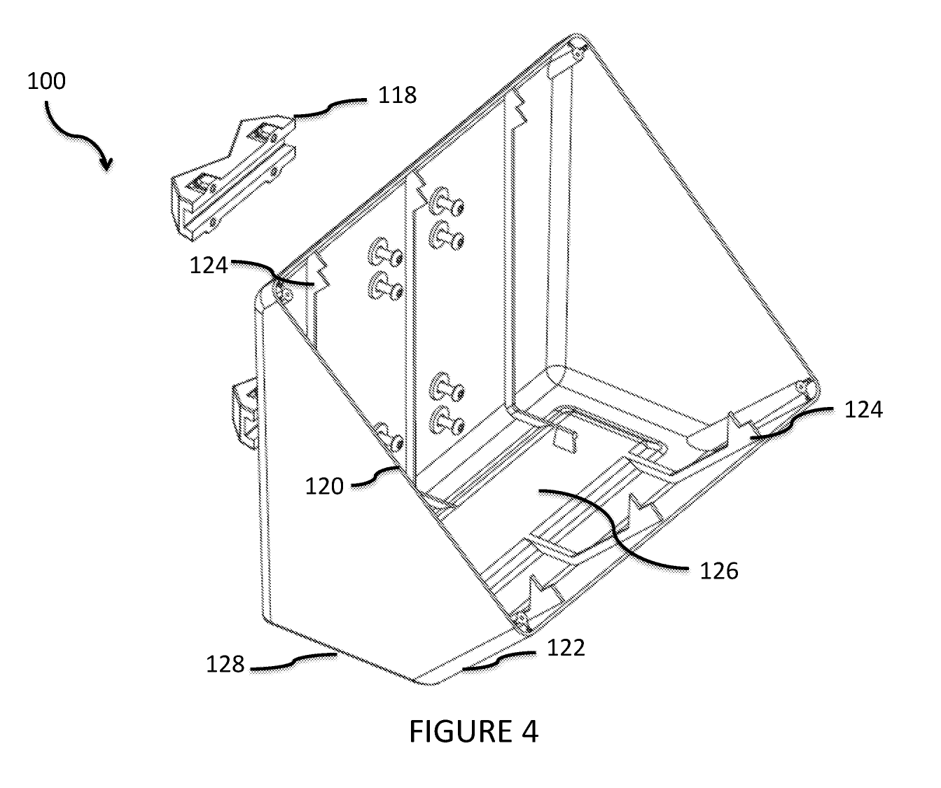

As shown in FIGS. 3-5 according to an embodiment of the present disclosure, holders 124 may be provided along opposite walls of case 100 and receive a portion of solar panel 112 (FIG. 4) and/or holder 110 (FIGS. 1 and 6). It should be appreciated that any number of holders 124 and/or any arrangement of holders 124 inside case 100 may be provided without departing from the present disclosure.

Referring to FIGS. 1 and 5-7, modular system 114 may be provided to hold and secure equipment inside of base 128. As shown in FIGS. 3-5, modular system 114 may snap inside supporting structure or recess 126 of base 128. Any number of brackets and/or compartments may be formed by modular system 114 in order to secure equipment 116 inside of case 100. Further, modular system 114 may snap inside supporting structure or recess 126 of base 128. By including modular system 114, case 100 may provide rapid assembly as well as safe and easy removal of the contents inside of case 100. Furthermore, inclusion of modular system 114 may maximize space and efficiency of case 100. It should be appreciated that modular system 114 may attach to base 128 using any fastening means including, but not limited to, hardware and adhesive without departing from the present disclosure. It be appreciated that equipment 116 may attach to modular system 114 using any fastening means including, but not limited to, a snap-fit, hardware and/or an adhesive without departing from the present disclosure. It should further be appreciated that equipment may include, but is not limited to, repeaters, controllers, batteries, AMI hardware, and/or electronics. For example, modular system 114 may house a battery holder including two batteries and a controller arranged in front of the battery holder. It should be appreciated that equipment 116 may be housed in holders that may assume a variety of shapes and/or sizes according to the type of equipment to be housed.

It may be advantageous to set forth definitions of certain words and phrases used in this patent document. The term “AMI hardware” may include any electronic equipment, non-electronic equipment, batteries, and repeaters. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A solar panel case, comprising:
a solar panel holder provided to support at least one solar panel;
a modular system provided to secure and house equipment in an interior of the case, wherein the modular system is removable; and
a face angled at approximately 45 degrees with respect to a base of the case, the face provided to form a frame to secure the at least one solar panel to the case.

2. The solar panel case of claim 1, wherein the modular system houses a battery holder and a controller.

3. The solar panel case of claim 1, wherein the solar panel holder secures the at least one solar panel in the interior of the case.

4. The solar panel case of claim 1, wherein the solar panel holder secures the at least one solar panel to an exterior of the case.

5. The solar panel case of claim 1, wherein the solar panel holder forms a tight seal with the face of the case provided to prevent liquid and solids from entering the interior of the case.

6. The solar panel case of claim 1, wherein the modular system is fixed in the interior of the case.

7. The solar panel case of claim 1, wherein the modular system includes at least one compartment, and maximizes space and efficiency of the case.

8. The solar panel case of claim 1, wherein the face is perpendicular to the base of the case and maximizes an amount of light received by the at least one solar panel.

9. The solar panel case of claim 1, further comprising:
one or more mounting components attached through a side of the case, wherein the mounting components secure the case to a supporting surface.

10. The solar panel case of claim 1, wherein the modular system provides safe removal of the equipment in the interior of the case.

11. The solar panel case of claim 1, wherein the modular system is secured inside of a recess of the base of the case.

12. The solar panel case of claim 1, wherein the case is configured to house advanced metering infrastructure hardware while supporting the at least one solar panel secured to the case.

13. A solar panel system, comprising:
a case having a face angled at approximately 45 degrees with respect to a base of the case;
at least one solar panel mounted inside of a holder, the holder provided to secure the at least one solar panel to an exterior of the case;
a removable battery holder secured in an interior of the case; and
a modular system configured to hold equipment including the battery holder in the interior of the case.

14. The system of claim 1, wherein the face is provided perpendicular to the base and maximizes an amount of light received by the at least one solar panel.

15. The system of claim 1, wherein the holder secures the at least one solar panel inside of the case or outside of the case.

16. The system of claim 1, wherein the modular system is removable and provides safe removal of the equipment held in the interior of the case.

17. The system of claim 1, wherein the modular system includes at least one compartment, and maximizes space and efficiency of the case.

18. The system of claim 1 further comprising:
one or more mounting components provided to secure the case to a supporting surface.

19. The system of claim 1, wherein the modular system is secured inside of a recess of the base of the case.

20. The system of claim 1, wherein the case is configured to house advanced metering infrastructure hardware while supporting the at least one solar panel secured to the case.
